(19) United States
(12) Patent Application Publication
(10) Pub. No.: US 2012/0173417 A1
(43) Pub. Date: Jul. 5, 2012

(54) METHODS AND SYSTEMS FOR BILLER-INITIATED REPORTING OF PAYMENT TRANSACTIONS

(76) Inventors: Darlene Lohman, Bartelso, IL (US); Mary L. Kelly, St. Louis, MO (US)

(21) Appl. No.: 12/981,351

(22) Filed: Dec. 29, 2010

(51) Int. Cl. G06Q 40/00

(52) U.S. Cl. 705/40

(57) ABSTRACT

A method for processing an electronic bill payment using a payment computer system coupled to a database. The payment computer includes an optional credit reporting tool. The method comprises receiving bill data representing a bill for payment directed to a consumer wherein the bill is associated with a biller, receiving payment data submitted on behalf of the consumer in response to the bill, determining that the biller is enrolled in the credit reporting tool wherein the biller selects enrollment in the credit reporting tool, comparing the payment data to the bill data, generating a payment record based on the comparison between the payment data and the bill data, and electronically transmitting the payment record to an appropriate credit bureau.

### BACKGROUND OF THE INVENTION

This invention relates generally to biller-initiated reporting of payment transactions, and more particularly to a network based system for processing payments between a consumer and a biller, the system being configured to allow the biller to request that a payment report be provided to a credit bureau for reporting payments that typically go unreported to the credit bureau.

Today, large lending institutions like banks, mortgage companies, and other creditors assume certain risk when they give loans to consumers for buying homes, financing cars, and paying for a college education. Creditors attempt to minimize the risk of these loans by carefully examining the credit history of the borrowers. If a borrower has a bad credit history, then the lender might not give the borrower a loan, or may charge the borrower a higher interest rate. A person's credit history is compiled and maintained by companies called credit reporting agencies or credit bureaus. Credit reporting agencies collect credit history from credit card companies, banks, mortgage companies and other creditors to create an in-depth credit report. The information in that report is also used to calculate a three-digit credit score. Every time a person applies for credit, the bank or credit card company calls up one or more of these credit reporting agencies to review that person's credit report and credit score. The lending institution will decide whether to extend a loan, and at what interest rate, largely based on the credit history reported by those agencies.

What is typically reported to the credit bureaus is the financial information from transactions with banks, stores, and finance companies. What is typically not reported to credit bureaus are consumer payments for recurring bills such as rent, utilities, and telecom. However, these recurring payments may get reported to credit bureaus if they are past due or if they go to collections, resulting only in the reporting of negative implications of recurring bills. This system of reporting may give a skewed picture of credit worthiness as a credit report would only reveal financial transactions with banks, credit companies, and the negative payment transactions of recurring bills, leaving out the timely everyday financial transactions with companies that typically do not report payments such as utility or telecom companies.

Attempts have been made to improve the credit reporting system. For example, some known companies have allowed consumers to drive the reporting process by setting up accounts with a third party that would store payment information from billers, such as landlords, who do not typically report to credit bureaus. The third party stores the payment information and then reports the information to the credit bureaus but only after the consumer approves the reporting to the credit bureau. The limitation to this known system is that the consumer selectively chooses the biller and allows only consumer approved payment information to be forwarded to the credit bureau. Thus, this known system essentially allows the consumer to manipulate the data being transmitted to the credit bureaus by giving the consumer the ability to pick and choose information that is only beneficial to the consumer.

Accordingly, a system for reporting credit transactions that typically are not reported to a credit bureau is needed. The system would report financial transactions involving the electronic payment of a bill by a consumer to a biller, wherein these payment transactions are tracked because they are not normally reported to a credit bureau. Moreover, this system would report a payment date and a payment amount to the credit bureau based on a request from the biller and not the consumer. This system would allow the credit bureau to generate a credit score of the consumer that better reflects the consumer's payment history.

### BRIEF DESCRIPTION OF THE INVENTION

In one aspect, a method for processing an electronic bill payment using a payment computer system coupled to a database is provided. The payment computer includes an optional credit reporting tool. The method comprises receiving, at the payment computer, bill data representing a bill for payment directed to a consumer wherein the bill is associated with a biller, and receiving, at the payment computer, payment data submitted on behalf of the consumer in response to the bill. The method further includes determining at the payment computer that the biller is enrolled in the credit reporting tool wherein the biller selects enrollment in the credit reporting tool, comparing the payment data to the bill data wherein the comparison is performed using the payment computer and the credit reporting tool, generating using the credit reporting tool a payment record based on the comparison between the payment data and the bill data, and electronically transmitting the payment record to an appropriate credit bureau.

In another aspect, a computer coupled to a database for processing an electronic bill payment is provided. The computer has an optional credit reporting tool. The computer is programmed to receive bill data representing a bill for payment directed to a consumer wherein the bill data comprises at least one of a payment due date, an amount due, an account number, a consumer name, balance information, a consumer address, a telephone number, and a presentment identifier. The computer is also programmed to receive payment data submitted on behalf of the consumer in response to the bill, determine that the biller is enrolled in the credit reporting tool wherein the biller selects enrollment in the credit reporting tool, compare the payment data to the bill data using the credit reporting tool, generate, using the credit reporting tool, a payment record based on the comparison between the payment data and the bill data, and transmit the payment record to an appropriate credit bureau.

In another aspect, a system for processing an electronic bill payment is provided. The system includes a database for storing information, and a server system having a credit reporting tool. The server is configured to be coupled to a consumer computer system, a biller computer system, and the database. The consumer computer system is associated with at least one of a consumer and a consumer service provider. The biller computer system is associated with at least one of a biller and a biller service provider. The server is further configured to receive bill data representing a bill for payment directed to a consumer from the biller computer system wherein the bill is associate with a biller, receive payment data from the consumer computer system in response to the bill, and determine that the biller is enrolled in the credit reporting tool, wherein the biller selects enrollment in the credit reporting tool. The server is further configured to compare the payment data to the bill data using the credit reporting tool, generate a payment record based on the comparison between the payment data and the bill data, and transmit the payment record to a credit bureau computer system.

In another aspect, a computer program embodied on a computer readable medium for processing an electronic bill payment using a payment computer coupled to a database is provided. The payment computer includes a credit reporting tool. The program comprises at least one code segment for instructing the payment computer to receive bill data representing a bill for payment directed to a consumer wherein the bill is associated with a biller, receive payment data submitted on behalf of the consumer in response to the bill, determine that the biller is enrolled in the credit reporting tool wherein the biller selects enrollment in the credit reporting tool, compare the payment data to the bill data using the credit reporting tool, generate a payment record based on the comparison between the payment data and the bill data, and transmit the payment record to an appropriate credit bureau.

### BRIEF DESCRIPTION OF THE DRAWINGS

FIG. 1A is a simplified block diagram of a conventional electronic financial service system.

FIG. 1B is a further depiction of the conventional electronic financial service system shown in FIG. 1A.

FIG. 2 is a simplified block diagram of an exemplary embodiment of a server architecture of a payment system having an optional credit reporting tool in accordance with one embodiment of the present invention.

FIG. 3 is an expanded block diagram of an exemplary embodiment of a server architecture of a payment system having an optional credit reporting tool in accordance with one embodiment of the present invention.

FIG. 4 illustrates an exemplary configuration of a client system shown in FIGS. 2 and 3.

FIG. 5 illustrates an exemplary configuration of a server system shown in FIGS. 2 and 3.

FIG. 6 is a flowchart illustrating an exemplary method of processing an electronic payment by the payment system shown in FIGS. 2 and 3.

FIG. 7 is a more detailed flowchart illustrating an exemplary method of enrollment within the payment system shown in FIGS. 2 and 3.

FIG. 8 is a more detailed flowchart illustrating an exemplary method of bill payment using the payment system shown in FIGS. 2 and 3.

FIG. 9 is a more detailed flowchart illustrating an exemplary method of generating a payment report using the payment system shown in FIGS. 2 and 3.

### DETAILED DESCRIPTION OF THE INVENTION

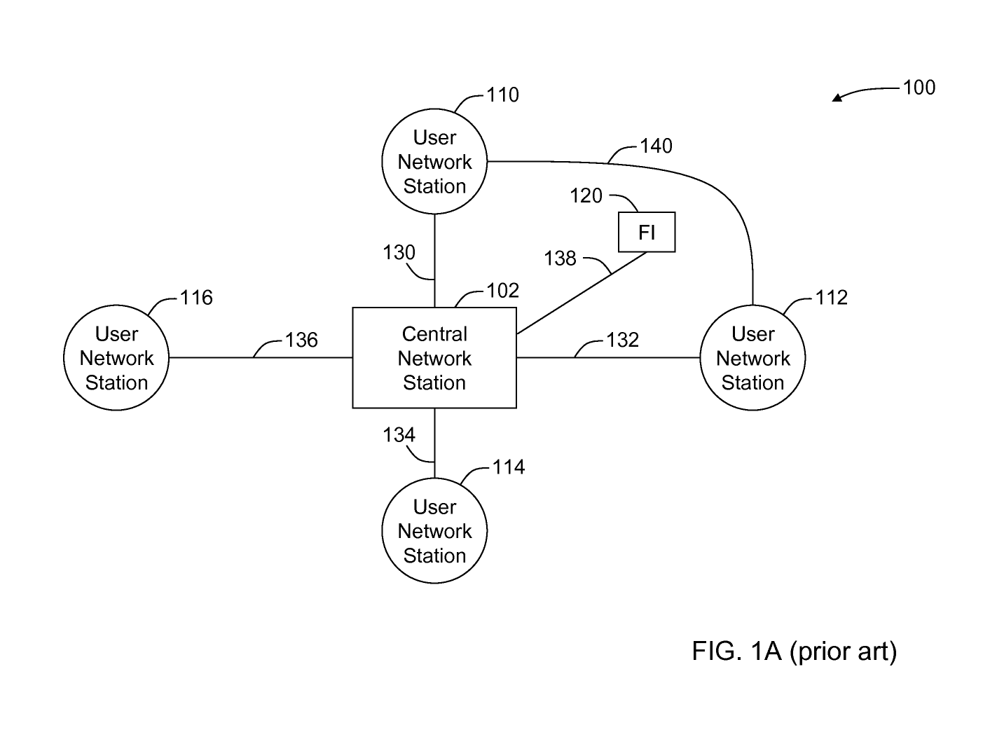

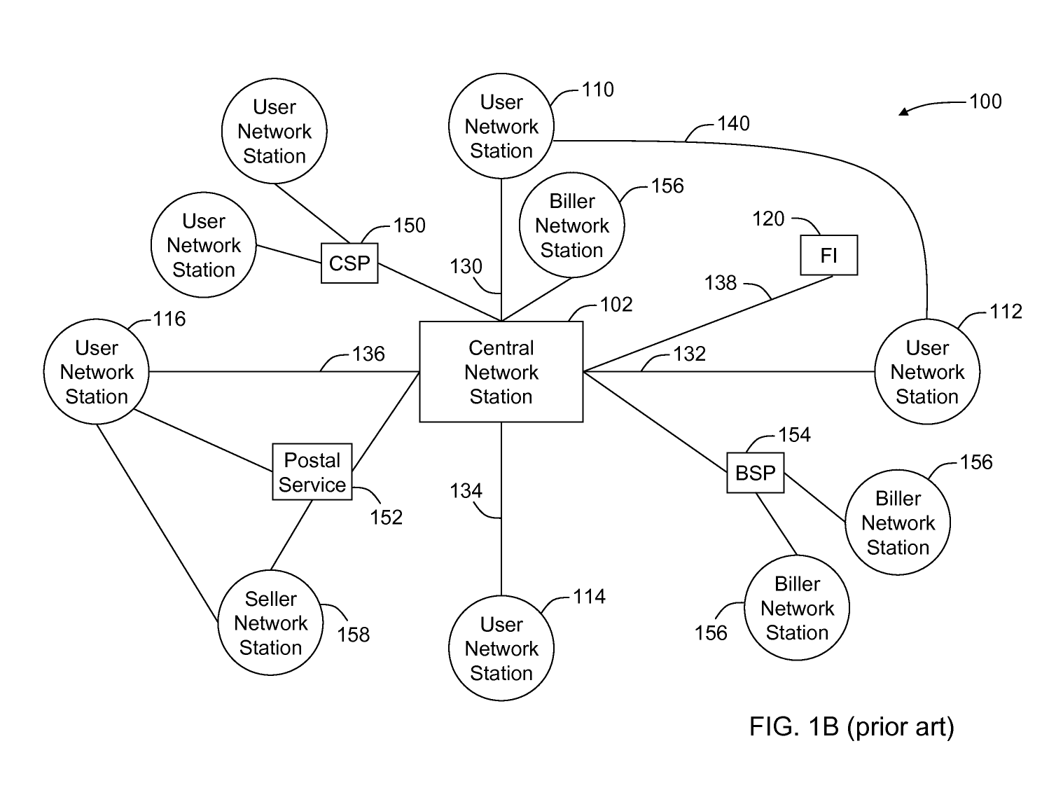

The present disclosure is directed to processing an electronic bill payment and reporting the associated payment information to a credit bureau at the request of the biller. The process begins with an enrollment step in which a biller enrolls with a payment system having an optional credit reporting tool so that the biller is also enrolled with the credit reporting tool. By so doing, the biller receives an optional credit reporting service provided by the payment system. As explained below, in the example embodiment, the option of receiving the credit reporting service is up to the selection or choosing of the biller. More specifically, the payment system may include a central payment processor such as, for example, one operated by an interchange network. After enrollment, the biller will issue a bill to a consumer for a good or service provided by the biller to the consumer. The bill may take the form of an electronic bill including bill data transmitted electronically from the biller or its representative to the consumer or his/her representative, or the bill may take the form of a paper bill mailed to the consumer. The consumer electronically pays the bill using the payment system. The central payment processor determines whether the bill was timely paid by the consumer and whether a proper amount of the bill was paid. Upon the request of the biller, the central payment processor, using the credit reporting tool, generates and transmits a payment report to a credit bureau with the payment information (e.g., payment date, due date, payment amount, due amount, etc.) included within the payment report. The credit bureau is then able to use the payment report to update the credit score of the consumer such that the consumer's credit report more accurately reflects the payment history of the consumer. These types of payments are typically the kind that go unreported to the credit bureaus. FIGS. 1-5 are used to illustrate the hardware involved in completing these steps.

A technical effect of the systems and processes described herein includes at least one of: (a) enrolling a biller with a central payment processor having an optional credit reporting tool such that the biller is enrolled to receive a credit reporting service; (b) storing consumer data at the payment processor wherein the consumer data includes data relating to the consumer such as the name of the consumer and an account number associated with the consumer for paying bills; (c) receiving at the payment processor a consumer identifier for consumers receiving bills from the biller through the payment processor; (d) storing the consumer identifiers at the payment processor with the consumer data; (e) receiving bill data representing a bill from the biller at the payment processor; (f) posting the bill data to the appropriate consumer account; (g) receiving consumer payment data from the consumer at the payment processor; (h) transmitting the received consumer payment data to the biller by the payment processor; (i) using the payment processor to match the consumer payment data to the stored bill data; (j) comparing the consumer payment data to the stored bill data, (k) generating a payment report, using the credit reporting tool, describing the comparison between the consumer payment data and the bill data; (l) storing the payment report in the database; and (m) transmitting the payment report to the credit bureau so that the credit bureau can factor the payment by the consumer into the consumer's credit score.

In one embodiment, a computer program is provided, and the program is embodied on a computer readable medium and utilizes a Structured Query Language (SQL) with a user interface front-end for administration and a report generator. In an exemplary embodiment, the system is web enabled and is run on a business-entity intranet. In yet another embodiment, the system is fully accessed by individuals having an authorized access outside the firewall of the business-entity through the Internet. In a further exemplary embodiment, the system is being run in a Windows® environment (Windows is a registered trademark of Microsoft Corporation, Redmond, Wash.). In yet another embodiment, the system is run on a mainframe environment and a UNIX server environment (UNIX is a registered trademark of AT&T New York, N.Y.). The application is flexible and designed to run in various different environments without compromising any major functionality. In some embodiments, the system includes multiple components distributed among a plurality of computing devices. One or more components may be in the form of computer-executable instructions embodied in a computer readable medium.

The systems and processes are not limited to the specific embodiments described herein. In addition, components of each system and each process can be practiced independent and separate from other components and processes described herein. Each component and process also can be used in combination with other assembly packages and processes.

Embodiments described herein access data stored in one or more data sources or databases. The terms data source and database are used interchangeably herein. A data source may include, but is not limited to: database server software (e.g., ORACLE DATABASE, MICROSOFT SQL SERVER) executing on one or more computing devices; one or more structured files; one or more text files; binary data in one or more files; one or more serialized objects; and/or one or more data lookup services, such as a web service.

The following detailed description illustrates embodiments of the invention by way of example and not by way of limitation. It is contemplated that the invention has general application to processing financial transaction data by a third party in industrial, commercial, and residential applications. As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

FIG. 1A is a generalized exemplary depiction of a conventional electronic financial service network 100. In a most basic form, such a network typically comprises a central network station 102 in communication with multiple user network stations 110, 112, 114, 116. The central network station is sometimes referred to as an interchange network. Network users, who are consumers of the financial service network 100, direct the central network station 102 to perform or facilitate financial transactions and/or services on their behalf. These directions are made via user network stations 110-116. A user network station is typically a personal computer, though it could be another type device. Another type device could be, but is not limited to, a telephone, a personal digital assistant, a set top box, or a computing device even more powerful than a personal computer. The financial transactions and services typically include, but are not limited to, bill and/or invoice presentment, bill and/or invoice payment, investment services, person-to-person payments, transmissions of financial information, home banking transactions, and purchase transactions. The central network station 102 conventionally maintains a central repository of information relating to services and transactions performed and/or facilitated and disseminates portions of this information to and between respective participants in the network 100, including those associated with user network stations 110-116 as well as other participants to be discussed below. In providing and/or facilitating some electronic financial services, the central network station 102 causes funds to move among and between deposit accounts associated with various ones of the network users and a deposit account associated with the central network station 102 maintained at a financial institution (FI) 120. Additionally, other types of accounts are often used to move funds, such as stored value accounts and credit accounts.

Each of the user network stations 110-116 communicates with the central network station 102 via a communication link 130, 132, 134, 136 and 138. A communication link can be established via, but is not limited to, conventional dial-up phone service, wireless phone service, including digital, analog and hybrid systems, an intranet, an extranet, a LAN, a WAN, and the Internet. Additionally, two or more of the user network stations 110-116 often communicate directly with one another via a communication link. For example, as shown in FIG. 1A, user network stations 110 and 112 communicate with one another via communication link 140. Communications between a user network station and the central network station, as well as between user network stations, can be made in several forms. They can be real-time communications, also known as in-session communications, they can be made by asynchronous messaging, or they can be made by asynchronous batch file transmission and processing.

Oftentimes two or more user network stations communicate with one another via the central network station. For example, user network stations 114 and 116 communicate with one another via communication links 134 and 136, with the communications traveling through the central network station 102. The communications between user network stations are often the basis of the financial transactions and/or services performed or facilitated by the central network station 102. These communications include purchase agreements, investment agreements, as well as other agreements relating to financial matters. It should also be noted that communications between network users not made via user network stations can also be the basis of the financial transactions and/or services performed or facilitated by the central network station 102. Network users include, but are not limited to, individuals, businesses, educational institutions, and other organizations.

FIG. 1B is a further depiction of the conventional electronic financial service network 100 of FIG. 1A. FIG. 1B shows additional participants often found in conventional electronic financial service networks, as well as communication links between and among the additional and prior depicted network participants. It should be understood that not all conventional electronic financial service networks include each of the types of participants depicted in FIG. 1B. Furthermore, not all electronic financial service networks provide the same services. The exemplary electronic financial service network 100 includes a consumer service provider 150 (CSP), a postal service 152, a biller service provider 154 (BSP), additional user network stations, multiple biller network stations 156, and a seller network station 158. It will be appreciated that a biller and a seller are each network users. Furthermore, network stations associated with billers and sellers are, for clarity, labeled biller network stations and seller network stations to highlight their associated network user's roles in the electronic financial service network 100. It also will be appreciated that a given network user could have multiple roles. That is, a biller could also be a payer, and so on.

A consumer service provider 150 provides interface access to the central network station 102, and thus network 100, for some network users. A bank or other financial or investment institution is often a consumer service provider. A CSP is also known as a portal. Additionally, a CSP can also offer services to a network user beyond those offered by the central network station 102. Oftentimes the central network station 102 operates behind the scenes in relation to CSP 150. That is, the central network station 102 provides the functionality to provide and/or facilitate financial transactions and/or services, while CSP 150 controls the presentation of such functionality to a network user.

Billers, who access network 100 through biller network stations 156, often electronically present their consumer's bills or invoices for services rendered and/or products sold. The central network station 102 typically receives billing information from billers and then presents either summary or complete billing information to payers. Billers also often receive remittance advice via network 100 for payment of bills, both those presented via network 100, and those only paid via network 100. A biller's access to the central network station 102 is sometimes through a BSP 154 which processes bills for several billers.

The FI 120, introduced above, provides access to at least one financial institution network, including the Automated Clearing House (ACH) network or FEDWIRE network, for financial transactions performed or facilitated by the central network station 102. FI 120 also hosts at least one deposit account associated with network 100. The financial institution also provides other services for the network 100, including settlement and treasury functions. As shown in FIG. 1B, central network station 102 also directly accesses other type financial networks. These networks include credit card networks and ATM/POS networks.

A postal service 152 performs delivery of goods purchased by network users and tracks the movement of these goods. This service could be provided in concert with central network station 102. A postal service is a participant in payment-on-delivery transactions.

Introduced above, the central network station 102 causes movement of funds between and among deposit accounts. These movements of funds are either by paper movement or electronic movement. Paper movement of funds includes checks and drafts prepared under the direction of the central station 102. These checks or drafts may be drawn on an account associated with the central network station 102 and payable to a payee designated by a network user. Or, these checks or drafts may be drawn on an account maintained at a financial institution associated with a network user and payable to a payee designated by a network user or deposited into an account associated with the central network station 102.

Electronic movement of funds is also by direction of the central network station 102. As introduced above, the central network station 102 is associated with a financial institution 120 that performs electronic movement of funds on behalf of the central network station 102. Like paper movement of funds, electronic movement of funds may originate from an account associated with the central network station 102, or may originate from an account associated with a network user. A network user must provide account information to the central network station 102 so that the central network station 102 can access that network user's account, whether the access is electronic or paper.

Some electronic financial service networks are closed systems. In a closed system, funds only move among and between individuals or entities that have a pre-established relationship with the central network station of the respective network. Additionally, information typically flows exclusively electronically in closed systems. Individuals and entities with pre-established relationships with a central network station are known as registered users. In these closed systems, funds can move either electronically or by paper, though preferably electronically. Other electronic financial service networks are open systems. In an open system, funds can move not only among and between registered users, but also to unregistered recipients. For movement to an unregistered recipient, funds must move by paper methods, as a central network station directing the transaction does not have access to the recipient's account.

It will be recognized by one skilled in the art that electronic movement of funds is more efficient than paper movement of funds. This efficiency arises because of at least two reasons. First, the cost per transaction is less for electronic movement than paper movement. Second, electronic movements require less time to complete than paper movements. Likewise, it will be recognized that electronic movement of information is also more efficient than paper movement of information.

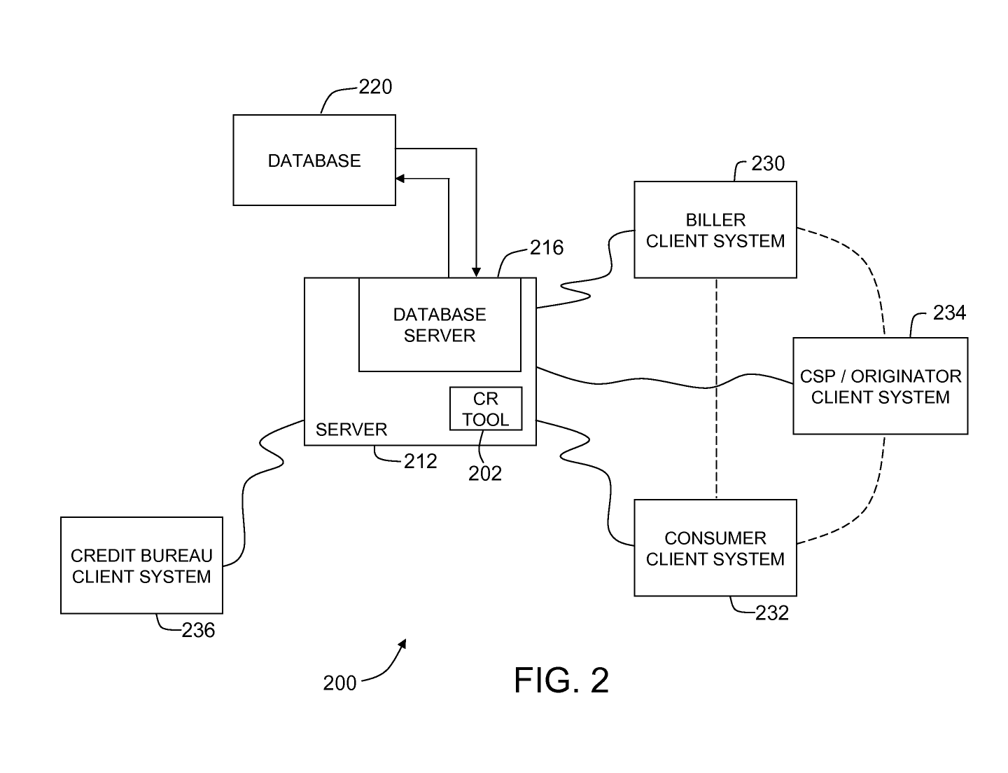

FIG. 2 is a simplified block diagram of an exemplary payment system 200 having an optional credit reporting tool 202 in accordance with one embodiment of the present invention. In one embodiment, payment system 200 is similar to the electronic financial service network 100 shown in FIGS. 1A and 1B with certain additional aspects, described herein in detail, directed to the electronic processing of financial transactions and creating a payment record for reporting to credit bureaus upon the request of a biller. More specifically, in the example embodiment, payment system 200 includes a server system 212, and a plurality of sub-systems, also referred to as client systems 230, 232, 234, and 236, connected to and/or in communication with server system 212. In the example embodiment, server system 212 is also referred to as a central payment processor that processes electronically submitted payment transactions submitted by a consumer after a bill is presented over the system to the consumer by a biller.

Server system also includes credit reporting tool 202 which is configured to provide an optional credit reporting service to billers enrolled with payment system 200. In other words, billers utilizing payment system 200 for processing bills for payment are enrolled within payment system 200. By enrolling in payment system 200, billers are able to submit their bills through payment system 200 for transmission to and payment receipt from corresponding consumers. Payment system 200 will recognize billers enrolled within system 200. Since payment system 200 includes optional credit reporting tool 202, billers are also able to enroll with credit reporting tool 202 if said biller chooses to receive the credit reporting services offered by credit reporting too 202. If a biller enrolls with credit reporting tool 202, system 200, when processing a bill from the enrolled biller, will first confirm that the biller is enrolled with system 200 and will then confirm that the biller is also enrolled in the optional credit reporting tool 202 before processing the bill and providing the credit reporting services described below.

In the example embodiment, client system 230 is associated with a biller, and therefore is referred to as biller system 230 or biller 230. Client system 232 is associated with a consumer, and therefore is referred to as consumer system 232 or consumer 232. Client system 234 is associated with a consumer service provider (CSP), and therefore is referred to as CSP system 234 or CSP 234. CSP 234 can also be referred to as an originator 234. Client system 236 is associated with a credit bureau, and therefore is referred to as credit bureau system 236.

In one embodiment, server system 212 is referred to as the RPPS® (Remote Payment and Presentment Service) system or the central payment processor. (RPPS is a registered trademark of MasterCard International Incorporated.) In an example embodiment, server system 212 may be associated with central network station 102. Likewise, biller 230 may be associated with biller network stations 156; consumer 232 may be associated with user network stations 110, 112, 114, and 116; and CSP 234 may be associated with CSP 150.

In one embodiment, client systems 230, 232, 234, and 236 are computers including a web browser, such that server system 212 is accessible to client systems 230, 232, 234, and 236, using the Internet. Client systems 230, 232, 234, and 236 are interconnected to the Internet through many interfaces including a network, such as a local area network (LAN) or a wide area network (WAN), dial-in-connections, cable modems, and special high-speed ISDN lines. Client systems 230, 232, 234, and 236 could be any device capable of interconnecting to the Internet including a web-based phone, personal digital assistant (PDA), or other web-based connectable equipment. A database server 216 is connected to a database 220 containing information on a variety of matters including payment data and consumer data, which is described below in detail. In an alternative embodiment, database 220 is stored remotely from server system 212 and may be non-centralized.

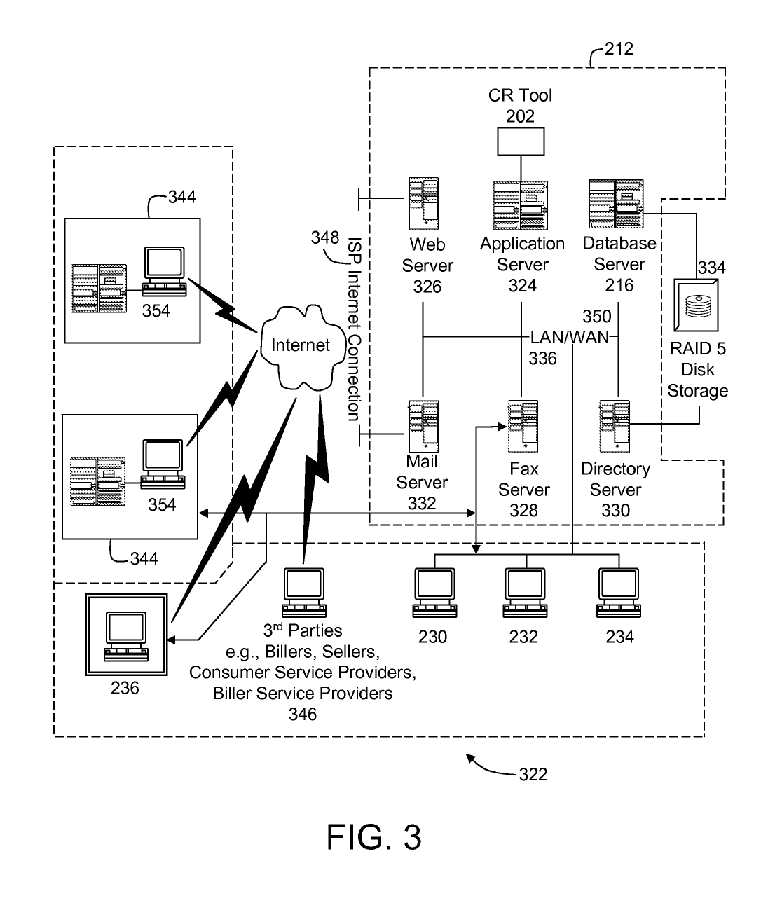

FIG. 3 is an expanded block diagram of an exemplary embodiment of a server architecture of a payment system 322 having the optional credit reporting tool 202 in accordance with one embodiment of the present invention. Components in system 322, identical to components of system 200 (shown in FIG. 2), are identified in FIG. 3 using the same reference numerals as used in FIG. 2. System 322 includes server system 212, credit reporting tool 202, and client systems 230, 232, 234, and 236. Server system 212 further includes database server 216, an application server 324, a web server 326, a fax server 328, a directory server 330, and a mail server 332. A disk storage unit 334 is coupled to database server 216 and directory server 330. Servers 216, 324, 326, 328, 330, and 332 are coupled in a local area network (LAN) 336. Client systems 230, 232, and 234 are coupled to LAN 236. Alternatively, workstations 230, 232, and 234 are coupled to LAN 236 using an Internet link or are connected through an intranet.

Each workstation 230, 232, and 234 is a personal computer having a web browser. Although the functions performed at the workstations typically are illustrated as being performed at respective workstations 230, 232, and 234, such functions can be performed at one of many personal computers coupled to LAN 236. Workstations 230, 232, and 234 are illustrated as being associated with separate functions only to facilitate an understanding of the different types of functions that can be performed by individuals having access to LAN 236.

Server system 212 is configured to be communicatively coupled to various individuals, including employees 344, and to third parties, e.g., billers, sellers, biller service providers, consumer service providers 346 using an ISP Internet connection 348. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 350, local area network 336 could be used in place of WAN 350.

In the exemplary embodiment, any authorized individual having a workstation 354 can access system 322. Workstations 354 are personal computers having a web browser and are configured to communicate with server system 212. Furthermore, fax server 328 communicates with remotely located client systems, including and credit bureau systems 236 using a telephone link. Fax server 328 is configured to communicate with other client systems 230, 232, and 234 as well.

Credit reporting tool 202 may be software and/or firmware stored within database 220 or on server 212, or in communication with server 212. Credit reporting tool 202 is configured to provide optional credit reporting services to billers submitting bills through payment system 322.

As used herein, the terms “software” and “firmware” are interchangeable, and include any computer program stored in memory for execution by personal computers, workstations, clients and servers, including random access memory (RAM), read-only memory (ROM), erasable programmable ROM (EPROM), electrically erasable programmable ROM (EEPROM), and/or non-volatile RAM (NVRAM) memory. The above memory types are exemplary only, and are thus not limiting as to the types of memory usable for storage of a computer program.

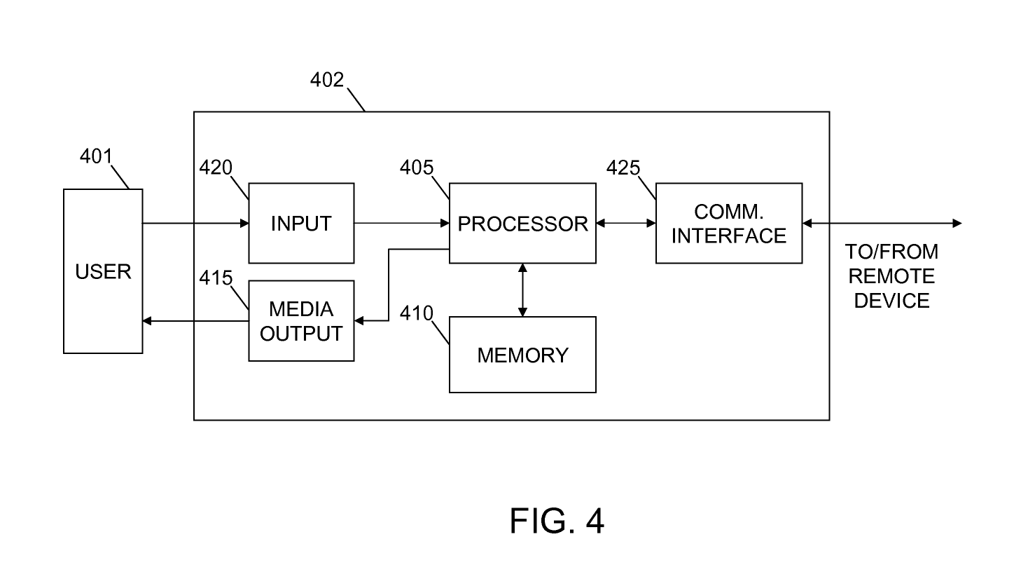

FIG. 4 illustrates an exemplary configuration of a user computing device 402 operated by a user 401. User computing device 402 may include, but is not limited to, client systems 230, 232, 234, and 236, and workstation 346, and workstation 354.

User computing device 402 includes a processor 405 for executing instructions. In some embodiments, executable instructions are stored in a memory area 410. Processor 405 may include one or more processing units (e.g., in a multi-core configuration). Memory area 410 is any device allowing information such as executable instructions and/or written works to be stored and retrieved. Memory area 410 may include one or more computer readable media.

User computing device 402 also includes at least one media output component 415 for presenting information to user 401. Media output component 415 is any component capable of conveying information to user 401. In some embodiments, media output component 415 includes an output adapter such as a video adapter and/or an audio adapter. An output adapter is operatively coupled to processor 405 and operatively couplable to an output device such as a display device (e.g., a liquid crystal display (LCD), organic light emitting diode (OLED) display, or “electronic ink” display) or an audio output device (e.g., a speaker or headphones).

In some embodiments, user computing device 402 includes an input device 420 for receiving input from user 401. Input device 420 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 415 and input device 420.

User computing device 402 may also include a communication interface 425, which is communicatively couplable to a remote device such as server system 212. Communication interface 425 may include, for example, a wired or wireless network adapter or a wireless data transceiver for use with a mobile phone network (e.g., Global System for Mobile communications (GSM), 3G) or other mobile data network (e.g., Worldwide Interoperability for Microwave Access (WIMAX)).

Stored in memory area 410 are, for example, computer readable instructions for providing a user interface to user 401 via media output component 415 and, optionally, receiving and processing input from input device 420. A user interface may include, among other possibilities, a web browser and client application. Web browsers enable users, such as user 401, to display and interact with media and other information typically embedded on a web page or a website from server system 212. A client application allows user 401 to interact with a server application from server system 212.

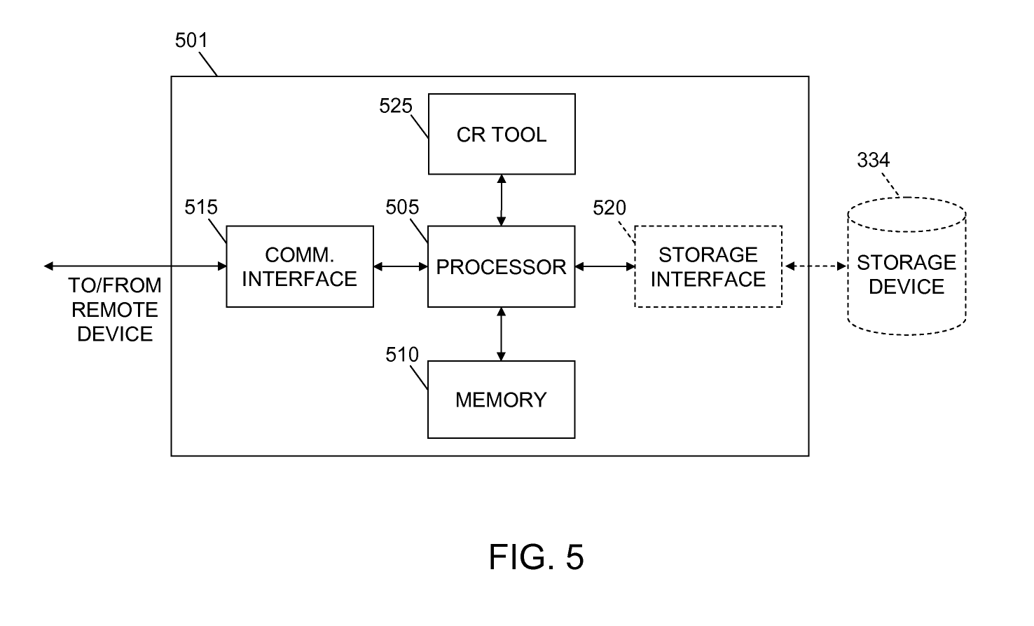

FIG. 5 illustrates an exemplary configuration of a server computing device 501 such as server system 212 (shown in FIG. 2 and also referred to as central payment processor). Server computing device 501 may include, but is not limited to, database server 216, application server 324, web server 326, fax server 328, directory server 330, and mail server 332.

Server computing device 501 also includes a processor 505 for executing instructions. Instructions may be stored in a memory area 510, for example. Processor 505 may include one or more processing units (e.g., in a multi-core configuration).

Processor 505 is operatively coupled to a communication interface 515 such that server computing device 501 is capable of communicating with a remote device such as user computing device 402 or another server computing device 501. For example, communication interface 515 may receive requests from any one of user computing devices 230, 232, 234, 236 via the Internet, as illustrated in FIG. 3.

Processor 505 may also be operatively coupled to a storage device 334. Storage device 334 is any computer-operated hardware suitable for storing and/or retrieving data. In some embodiments, storage device 334 is integrated in server computing device 501. For example, server computing device 501 may include one or more hard disk drives as storage device 334. In other embodiments, storage device 334 is external to server computing device 501 and may be accessed by a plurality of server computing devices 501. For example, storage device 334 may include multiple storage units such as hard disks or solid state disks in a redundant array of inexpensive disks (RAID) configuration. Storage device 334 may include a storage area network (SAN) and/or a network attached storage (NAS) system.

In some embodiments, processor 505 is operatively coupled to storage device 334 via a storage interface 520. Storage interface 520 is any component capable of providing processor 505 with access to storage device 334. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 334.

Processor 505 is also be operatively coupled to a credit reporting tool 525. Credit reporting tool 525 is the same as credit reporting tool 202 shown in FIG. 2. Credit reporting tool 525 is configured to provide an optional credit reporting service to billers such as enabling billers to request that payment records of consumers (i.e., reports showing whether consumers have timely paid and fully paid certain bills) be reported to an appropriate or preselected credit bureau. These are typically payment records that go unreported to credit bureaus.

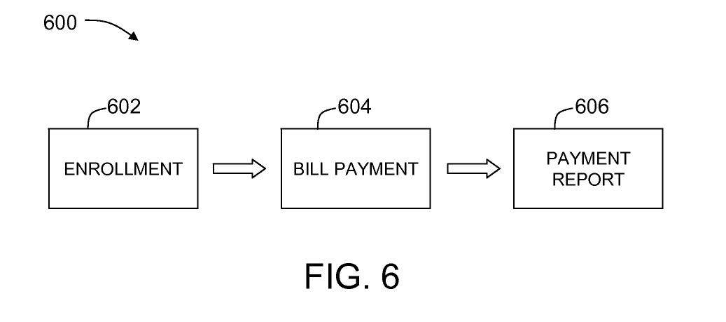

FIG. 6 is a flowchart illustrating an exemplary method 600 of processing an electronic payment by payment system 200 (shown in FIG. 2) and reporting such data to credit bureau system 236 (shown in FIG. 2). Referring to FIGS. 2 and 6, payment processor 212 achieves the technical effect by implementing method 600 which includes an enrollment step 602 wherein a biller 230 enrolls in a credit reporting service provided by the central network station 102 (shown in FIG. 1A) through server system 212. Specifically, biller 230 enrolls in optional credit reporting tool 202, which is configured to provide the credit reporting service described herein. After enrollment 602, consumer 232 makes a bill payment step 604 that involves consumer 232 paying a bill generated from biller 230 for services or goods provided by biller 230 to consumer 232. The central payment processor 212 generates a payment report 606 wherein the payment report is generated at the request of the biller using information gathered from bill payment step 604. The payment report is then electronically transmitted from central payment processor 212 to credit bureau system 236 so that the payment report can be used when calculating the credit score of consumer 232. The generation of the payment report and its reporting to the credit bureau is part of the credit reporting service provided by credit reporting tool 202.

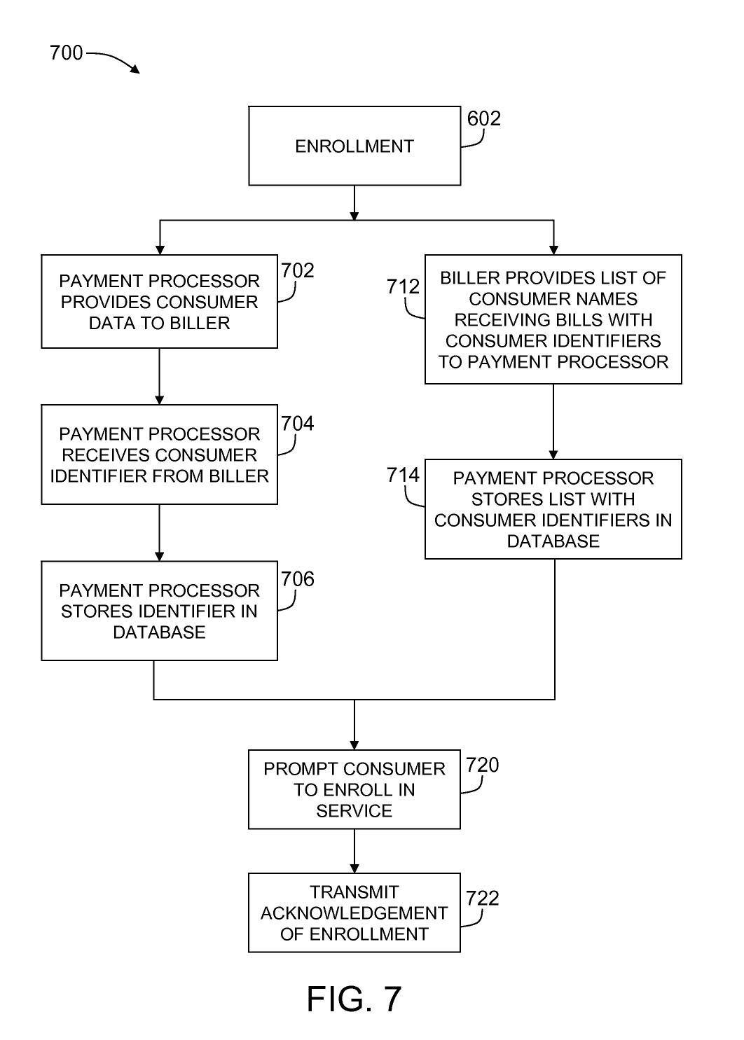

FIG. 7 is a more detailed flowchart illustrating an exemplary method 700 of enrollment step 602 (shown in FIG. 6). In an exemplary embodiment, biller 230 enrolls in a presentment/credit reporting service (P/CR service) offered by central network station 102 through server system/central payment processor 212 and credit reporting tool 202. The P/CR service enables biller 230 to request that a payment report be provided to at least one credit bureau system 236, wherein the payment report describes a payment history of consumer 232 with biller 230. The P/CR service described herein ensures that all financial transaction data submitted through the payment processor is reported to a credit bureau if the biller so elects, unlike other known payment and reporting systems that allow a consumer to selectively choose what financial transaction data is reported to a credit bureau.

In the example embodiment, biller 230 may enroll in the P/CR service in one of two ways. In a first embodiment, payment processor 212 provides 702 consumer data to biller 230, wherein the consumer data includes data for each consumer 232 that is currently paying bills from biller 230 using payment processor 212. For example, consumer data includes data relating to a particular consumer such as the name of the consumer and an account number associated with the consumer for paying bills. In response to providing 702 consumer data, payment processor 212 receives 704 a consumer identifier from biller 230 for each consumer included within the consumer data. Payment processor 212 stores 706 the consumer identifier with the consumer data in database 220. The consumer identifier is used by payment processor 212 for identifying each consumer to the credit bureau system 236 when a payment report is later provided to credit bureau 236. In the example embodiment, the consumer identifier includes any identifier that can be used for identifying a consumer to the credit bureau system 236 such as a partial social security number associated with the consumer or some other identifier.

In a second embodiment, biller 230 can enroll in the P/CR service by providing 712 a list of all consumer names that receive bills from biller 230 with a corresponding consumer identifier to payment processor 212. Payment processor 212 then stores 714 the list of consumer names in database 220 so that it can be accessed when a consumer makes a payment to biller 230 using payment system 200. Specifically, as a consumer makes a payment using payment system 200, payment processor 212 accesses database 220 and retrieves the consumer identifier associated with that particular consumer so that a payment report can be provided to credit bureau 236 with the associated consumer identifier. This allows credit bureau 236 to generate a credit score for this particular consumer.

In one embodiment, after biller 230 enrolls with payment processor 212 in the P/CR service, payment processor 212 is accessed directly by consumer 232 such that only bills associated with a single biller 230 are displayed on consumer system 232. In other words, a consumer, using consumer system 232, accesses a bill for a particular biller 230 that is presented by payment processor 212 for payment. This may be done through the biller's web site or another web site associated with the biller. In another embodiment, payment processor 212 creates a list of multiple billers 230 who have enrolled with payment processor 212 in the P/CR service, and provides the biller list to originator 234. Originator 234 then displays the list of enrolled billers such that a consumer can select one of the billers from the list of billers for making a payment. Specifically, the consumer selects the biller from the list and then selects the bill for presentment and payment.

In the example embodiment, whether consumer 232 access bills directly from payment processor 212 or through originator 234, payment processor 212 prompts 720 the consumer to enroll in the P/CR service to allow the consumer to receive bills generated by the biller 230 through payment processor 212. After consumer 232 enrolls in the P/CR service, payment processor 212 transmits 722 an acknowledgement of enrollment to consumer 232.

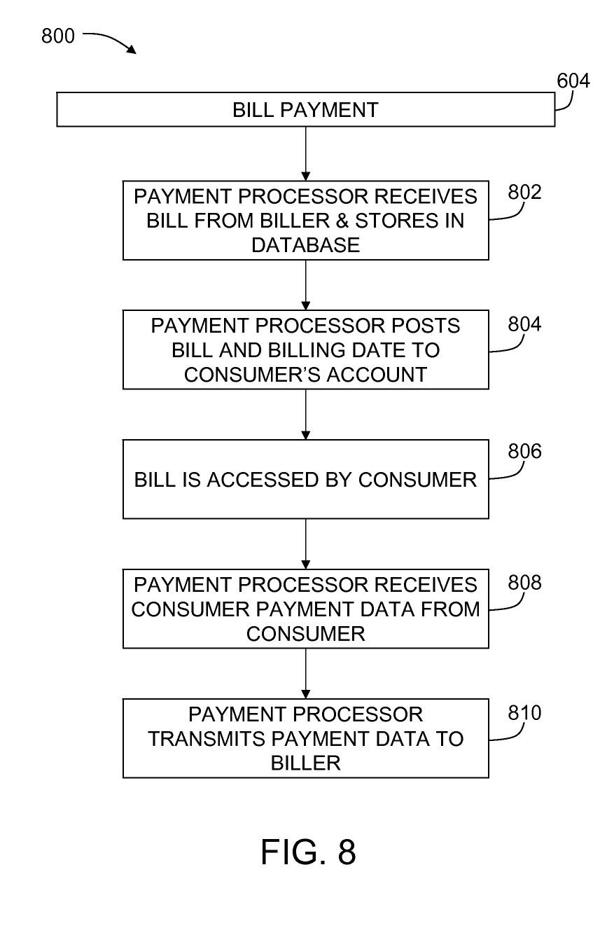

FIG. 8 is a more detailed flowchart illustrating an exemplary method 800 of bill payment step 604 (shown in FIG. 6). In the exemplary embodiment, payment processor 212 receives 802 bill data representing a bill generated and sent by biller 230 for presentment to consumer 232 and stores the bill data in database 220. The generated bill includes bill data, which includes, but is not limited to, a due date, an amount due, an account number, a consumer name, balance information, a consumer address, a telephone number, and a presentment identifier. Payment processor 212 posts 804 the bill and bill data to a consumer's account for viewing through originator 234 or directly from payment processor 212. In the exemplary embodiment, the posted bill is accessed 806 by consumer 232. Consumer 232 pays the accessed bill by electronically submitting payment data to payment processor 212. In an alternative embodiment, consumer 232 accesses and pays the posted bill through originator 234. The originator 234 then transmits payment data to payment processor 212. Payment processor 212 receives 808 the payment data associated with the payment of the bill. The payment data includes, but is not limited to, a date paid, an amount paid, an account number for the consumer, and a presentment identifier. Payment processor 212 transmits 810 the payment data to biller 230 for recordation such that biller 230 is able to post the payment data into its records.

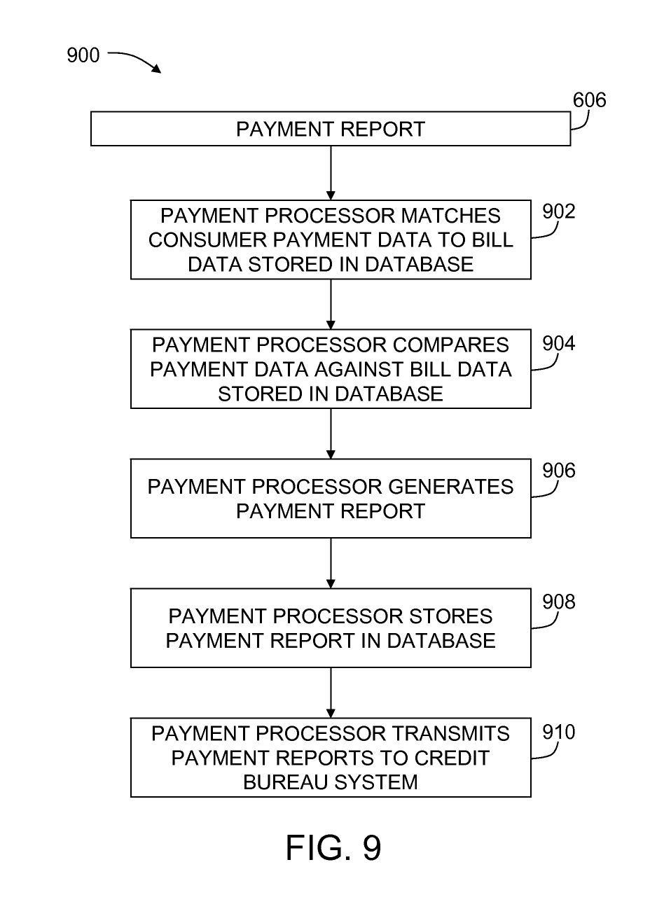

FIG. 9 is a more detailed flowchart illustrating an exemplary method 900 of payment report step 606 (shown in FIG. 6). In the exemplary embodiment, payment processor 212 uses the presentment identifier received by originator 234 from consumer 232 with the payment data to match 902 the payment data to a corresponding bill data stored in database 220. After matching 902, payment processor 212 compares 904 at least some of the payment data, such as the amount paid and date paid, to the stored bill data, namely the corresponding amount due and the date due. Payment processor 212 uses the comparison of the payment data to the bill data to generate 906 a payment report describing this consumer's payment. The payment report includes, but is not limited to, the consumer identifier previously provided by the biller for this particular consumer, whether the payment made by the consumer was equal to or greater than the amount due, and whether the payment made by the consumer was timely paid (i.e., before the due date). The payment report is stored 908 in database 220. The payment record is continually updated by payment processor 212 as the consumer makes other payments using payment system 200. The payment reports, stored in database 220 by payment processor 212, are periodically (daily, weekly or monthly) transmitted 910 to credit bureau system 236 such that credit bureau 236 is able to update its credit score for consumer 232 to account for the consumer's payment history with biller 230 over payment processor 212. The payment records can be sent to credit bureau system 236 in any time interval, including but not limited to, weekly, bi-weekly, quarterly, and yearly. Alternatively, the payment records can be sent directly to credit bureau system 236 without being stored in database 220.

In the example embodiment, the step of generating a payment record may further include retrieving bill data stored in the database based on the received payment data wherein payment data includes an identifier corresponding with the bill data, comparing an amount paid and a date paid by the consumer from the payment data to an amount due and a payment due date from the bill data, determining whether a required amount has been timely paid by the consumer to the biller based on the comparison, and generating a payment record indicating at least whether payment by the consumer for the bill was at least one of on time, late, paid in full, paid as agreed, partially paid, and not paid.

In an alternative embodiment, the payment records are stored within database 230 by payment processor 212 for future reference and disputes. In other words, payment processor 212 stores the payment records such that billers 230 and credit bureau system 236 can access payment processor 212 to inquire about specific payments to help resolve disputes that may arise over payments. Credit bureau system 236 uses the payment report to calculate a credit rating of the consumer.

As discussed herein, database 230 stores information relating to consumers such as consumer data including, but not limited to a name, address, phone number, account number, and social security number. Database 230 may also store data generated as part of payment and reporting conducted over the payment and reporting system including data relating to originators, billers, credit bureaus, payment records, and payment reports. Database 230 may also store data relating to originators, billers, and credit bureaus. Database 230 may also store data relating to transaction terms, financing data, and any other data related to operation of system 200. Database 230 may include a single database having separated sections or partitions or may include multiple databases, each being separate from each other.

The systems and processes described herein enables payment processor 212 to report non-typical credit transactions, and more particularly to electronically process and transmit the payment information. A non-typical payment or credit transaction is a financial transaction between a consumer and a biller that is not typically reported to a credit bureau such as rent payments, utility payments, or other similar such payments made by a consumer. The payment system enables credit bureau system 236 to have more payment information to create a more accurate credit score.

The systems and processes are not limited to the specific embodiments described herein. In addition, components of each system and each process can be practiced independent and separate from other components and processes described herein. Each component and process also can be used in combination with other assembly packages and processes.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense. For example, the example embodiments described herein relate to electronic bill payment between a consumer and a biller and reporting such payment information to a credit bureau. In at least some cases, the consumer described herein includes an individual consumer, and the biller includes a business entity. Thus, the individual consumer may use the system described herein to electronically submit a bill payment to a business entity biller. However, in another embodiment, the consumer may include a first business entity, and the biller includes a second business entity. Thus, the first business entity/consumer may use the system described herein to electronically submit a bill payment to the second business entity/biller. Accordingly, as described herein a consumer includes both an individual consumer and a business entity consumer, and the systems and processes described herein can be used in an individual consumer to business biller relationship or in a business consumer to business biller relationship.

A computer device, such as those described herein, includes at least one processor or processing unit and a system memory. The computer device typically has at least some form of computer readable media. By way of example and not limitation, computer readable media include computer storage media and communication media. Computer storage media include volatile and nonvolatile, removable and non-removable physical media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

The methods described herein may be encoded as executable instructions embodied in a computer readable medium, including, without limitation, a computer storage medium, a storage device, and/or a memory device. Such instructions, when executed by a processor, cause the processor to perform at least a portion of the methods described herein.

Although the present invention is described in connection with an exemplary bill payment processing system environment, embodiments of the invention are operational with numerous other general purpose or special purpose financial transaction/bill payment processing system environments or configurations. The bill payment processing system environment is not intended to suggest any limitation as to the scope of use or functionality of any aspect of the invention. Moreover, the bill payment processing system environment should not be interpreted as having any dependency or requirement relating to any one or combination of components illustrated in the exemplary operating environment. Examples of well known bill payment processing systems, environments, and/or configurations that may be suitable for use with the embodiments described herein include, but are not limited to, embedded computer devices, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments may be described in the general context of computer-executable instructions, such as program components or modules, executed by one or more computers, processors, and/or other devices. Aspects of the invention may be implemented with any number and organization of components or modules. For example, embodiments are not limited to the specific computer-executable instructions or the specific components or modules illustrated in the figures and described herein. Alternative embodiments may include different computer-executable instructions or components having more or less functionality than illustrated and described herein.

The order of execution or performance of the operations in the embodiments illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the described embodiments.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated processes. The patentable scope of the invention is defined by the claims, and may include other examples that occur to those skilled in the art. These other examples are intended to be within the scope of the claims if they have structural elements that do not differ from the literal language of the claims, or if they include equivalent structural elements with insubstantial differences from the literal languages of the claims.

While the invention has been described in terms of various specific embodiments, those skilled in the art will recognize that the invention can be practiced with modification within the spirit and scope of the claims.

What is claimed is:

1. A method for processing an electronic bill payment using a payment computer system coupled to a database, the payment computer including an optional credit reporting tool, said method comprising:
receiving, at the payment computer, bill data representing a bill for payment directed to a consumer, the bill associated with a biller;
receiving, at the payment computer, payment data submitted on behalf of the consumer in response to the bill;
determining at the payment computer that the biller is enrolled in the credit reporting tool, wherein the biller selects enrollment in the credit reporting tool;
comparing the payment data to the bill data, the comparison is performed using the payment computer and the credit reporting tool;
generating, using the credit reporting tool, a payment record based on the comparison between the payment data and the bill data; and
electronically transmitting the payment record to an appropriate credit bureau.

2. A method in accordance with claim 1 wherein receiving bill data further comprises:
electronically receiving bill data from a first remote computer, wherein the bill data includes at least one of a payment due date, an amount due, an account number, a consumer name, balance information, a consumer address, a telephone number, and a presentment identifier.

3. A method in accordance with claim 2 further comprising:
transmitting an enrollment message from the payment computer to the first remote computer, the first remote computer associated with the biller, wherein the enrollment message prompts the biller to enroll in the credit reporting tool; and
receiving an enrollment response message from the first remote computer, wherein the enrollment response message indicates whether the biller enrolls in the credit reporting tool.

4. A method in accordance with claim 1 wherein receiving payment data further comprises:
electronically receiving payment data from a second remote computer, the payment data representing payment by the consumer of the bill, wherein the payment data includes at least one of a date paid, an amount paid, an account number for the consumer, and a presentment identifier.

5. A method in accordance with claim 1 further comprising:
enrolling the biller in the credit reporting tool before receiving the bill data for payment at the payment computer; and
storing in the database a consumer directory associated with the enrolled biller, the consumer directory including a consumer identifier for each consumer account of the biller registered for electronic processing of payments by the payment computer, and payment terms for each consumer account included within the consumer directory.

6. A method in accordance with claim 1 further comprising:
enrolling the biller in the credit reporting tool;
transmitting consumer data to a first remote computer, the first remote computer associated with the biller, wherein the consumer data includes data identifying each consumer currently paying bills from the biller over the central computer;
receiving a consumer identifier from the first remote computer for each consumer included within the consumer data; and
storing the received consumer identifiers in the database.

7. A method in accordance with claim 1 wherein generating a payment record further comprises:
retrieving bill data stored in the database based on payment data, wherein payment data includes an identifier corresponding with the bill data;
comparing an amount paid and a date paid by the consumer from the payment data to an amount due and a payment due date from the bill data;
determining whether a required amount has been timely paid by the consumer to the biller based on the comparison; and
generating a payment record indicating at least whether payment by the consumer for the bill was at least one of on time, late, paid in full, paid as agreed, partially paid, and not paid.

8. A method in accordance with claim 1 wherein generating a payment record further comprises:
formatting the payment record to contain consumer identifiable data for transmission to a first credit bureau, wherein the first credit bureau is preselected by the biller.

9. A method in accordance with claim 1 wherein electronically transmitting the payment record further comprises:
transmitting the payment record to a first credit bureau for updating a credit score for the consumer at the first credit bureau with the payment record.

10. A computer coupled to a database for processing an electronic bill payment, the computer having an optional credit reporting tool, said computer programmed to:
receive bill data representing a bill for payment directed to a consumer, the bill data comprising at least one of a payment due date, an amount due, an account number, a consumer name, balance information, a consumer address, a telephone number, and a presentment identifier.
receive payment data submitted on behalf of the consumer in response to the bill;
determine that the biller is enrolled in the credit reporting tool, the biller selecting enrollment in the credit reporting tool;
compare the payment data to the bill data using the credit reporting tool;
generate, using the credit reporting tool, a payment record based on the comparison between the payment data and the bill data; and
transmit the payment record to an appropriate credit bureau.

11. A computer in accordance with claim 10, wherein the computer is further programmed to:
transmit an enrollment message to a first remote computer, the first remote computer associated with the biller, wherein the enrollment message prompts the biller to enroll in the credit reporting tool; and
receive an enrollment response message from the first remote computer, wherein the enrollment response message indicates whether the biller enrolls in the credit reporting tool.

12. A computer in accordance with claim 10, wherein the computer is further programmed to:
receive payment data from a second remote computer, the payment data representing payment by the consumer of the bill, wherein the payment data includes at least one of a date paid, an amount paid, an account number for the consumer, and a presentment identifier.

13. A computer in accordance with claim 10, wherein the computer is further programmed to:
prompt the biller to enroll in the credit reporting tool before receiving the bill data for bill payment; and
store in the database a consumer directory associated with the enrolled biller, the consumer directory including a consumer identifier for each consumer account of the biller registered for electronic processing of payments by the payment computer, and payment terms for each consumer account included within the consumer directory.

14. A computer in accordance with claim 10, wherein the computer is further programmed to:
enroll the biller in the credit reporting tool;
transmit consumer data to a first remote computer, the first remote computer associated with the biller, wherein the consumer data includes data identifying each consumer currently paying bills from the biller over the computer;
receive a consumer identifier from the first remote computer for each consumer included within the consumer data; and
store the received consumer identifiers in the database.

15. A computer in accordance with claim 10, wherein the computer is further programmed to:
retrieve bill data stored in the database based on payment data, wherein payment data includes an identifier corresponding with the bill data;
compare an amount paid and a date paid by the consumer from the payment data to an amount due and a payment due date from the bill data;
determine whether a required amount has been timely paid by the consumer to the biller based on the comparison; and
generate a payment record indicating at least whether payment by the consumer for the bill was at least one of on time, late, paid in full, paid as agreed, partially paid, and not paid.

16. A computer in accordance with claim 10, wherein the computer is further programmed to:
transmit the payment record to a first credit bureau for updating a credit score for the consumer at the first credit bureau with the payment record.

17. A system for processing an electronic bill payment, said system comprising:
a database for storing information; and
a server system comprising a credit reporting tool, the server configured to be coupled to a consumer computer system, a biller computer system, and the database, wherein the consumer computer system is associated with at least one of a consumer and a consumer service provider, the biller computer system is associated with at least one of a biller and a biller service provider, wherein said server is further configured to:
receive bill data representing a bill for payment directed to a consumer from the biller computer system, the bill associate with a biller;
receive payment data from the consumer computer system in response to the bill;
determine that the biller is enrolled in the credit reporting tool, wherein the biller selects enrollment in the credit reporting tool;
compare the payment data to the bill data using the credit reporting tool;
generate a payment record based on the comparison between the payment data and the bill data; and
transmit the payment record to a credit bureau computer system.

18. A system in accordance with claim 17, wherein the server is further configured to:
receive bill data from the biller computer system, wherein the bill data includes at least one of a payment due date, an amount due, an account number, a consumer name, balance information, a consumer address, a telephone number, and a presentment identifier; and
receive payment data from the consumer computer system, the payment data representing payment by the consumer of the bill, wherein the payment data includes at least one of a date paid, an amount paid, an account number for the consumer, and a presentment identifier.

19. A system in accordance with claim 17, wherein the server is further configured to:
transmit an enrollment message to the biller computer system, the biller computer system associated with the biller, wherein the enrollment message prompts the biller to enroll in the credit reporting tool; and
receive an enrollment response message from the biller computer system, wherein the enrollment response message indicates whether the biller enrolls in the credit reporting tool.

20. A system in accordance with claim 17, wherein the server is further configured to:
enroll the biller in the credit reporting tool before receiving the bill data for bill payment; and
store in the database a consumer directory associated with the enrolled biller, the consumer directory including a consumer identifier for each consumer account of the biller registered for electronic processing of payments by the payment computer, and payment terms for each consumer account included within the consumer directory.

21. A system in accordance with claim 17, wherein the server is further configured to:
enroll the biller in the credit reporting tool;
transmit consumer data to the biller computer system, the biller computer system associated with the biller, wherein the consumer data includes data identifying each consumer currently paying bills from the biller over the server system;
receive a consumer identifier from the biller computer system for each consumer included within the consumer data; and
store the received consumer identifiers in the database.

22. A system in accordance with claim 17, wherein the server is further configured to:
retrieve bill data stored in the database based on payment data, wherein payment data includes an identifier corresponding with the bill data;
compare an amount paid and a date paid by the consumer from the payment data to an amount due and a payment due date from the bill data;
determine whether a required amount has been timely paid by the consumer to the biller based on the comparison; and
generate a payment record indicating at least whether payment by the consumer for the bill was timely made and paid in full.

23. A computer program embodied on a computer readable medium for processing an electronic bill payment using a payment computer coupled to a database, the payment computer including a credit reporting tool, said program comprising at least one code segment for instructing the payment computer to:
receive bill data representing a bill for payment directed to a consumer, the bill associated with a biller;
receive payment data submitted on behalf of the consumer in response to the bill;
determine that the biller is enrolled in the credit reporting tool, wherein the biller selects enrollment in the credit reporting tool;
compare the payment data to the bill data using the credit reporting tool;
generate a payment record based on the comparison between the payment data and the bill data; and
transmit the payment record to an appropriate credit bureau.

24. A computer program in accordance with claim 23 further comprising at least one code segment that instructs the payment computer to:
receive bill data from a first remote computer, wherein the bill data includes at least one of a payment due date, an amount due, an account number, a consumer name, balance information, a consumer address, a telephone number, and a presentment identifier.

25. A computer program in accordance with claim 24 further comprising at least one code segment that instructs the payment computer to:
transmit an enrollment message from the payment computer to the first remote computer, the first remote computer associated with the biller, wherein the enrollment message prompts the biller to enroll in the credit reporting tool; and
receive an enrollment response message from the first remote computer, wherein the enrollment response message indicates whether the biller enrolls in the credit reporting tool.

26. A computer program in accordance with claim 23 further comprising at least one code segment that instructs the payment computer to:
receive payment data from a second remote computer, the payment data representing payment by the consumer of the bill, wherein the payment data includes at least one of a date paid, an amount paid, an account number for the consumer, and a presentment identifier.

27. A computer program in accordance with claim 23 further comprising at least one code segment that instructs the payment computer to:
enroll the biller in the credit reporting tool before receiving the bill for payment; and
store in the database a consumer directory associated with the enrolled biller, the consumer directory including a consumer identifier for each consumer account of the biller registered for electronic processing of payments by the payment computer, and payment terms for each consumer account included within the consumer directory.

28. A computer program in accordance with claim 23 further comprising at least one code segment that instructs the payment computer to:
enroll the biller in the credit reporting tool;
transmit consumer data to a first remote computer, the first remote computer associated with the biller, wherein the consumer data includes data identifying each consumer currently paying bills from the biller over the central computer;
receive a consumer identifier from the first remote computer for each consumer included within the consumer data; and
store the received consumer identifiers in the database.

29. A computer program in accordance with claim 23 further comprising at least one code segment that instructs the payment computer to:
retrieve bill data stored in the database based on payment data, wherein payment data includes an identifier corresponding with the bill data;
compare an amount paid and a date paid by the consumer from the payment data to an amount due and a payment due date from the bill data;
determine whether a required amount has been timely paid by the consumer to the biller based on the comparison; and
generate a payment record indicating at least whether payment by the consumer for the bill was at least one of on time, late, paid in full, paid as agreed, partially paid, and not paid.

30. A computer program in accordance with claim 23 further comprising at least one code segment that instructs the payment computer to:
transmit the payment record to a first credit bureau for updating a credit score for the consumer at the first credit bureau with the payment record.
